(19) United States
(12) Patent Application Publication
(10) Pub. No.: US 2011/0219951 A1
(43) Pub. Date: Sep. 15, 2011

(54) Method and mitigating mercury vapor emissions during storing, staging, handling and transportation of mercury containing universal waste

(76) Inventor: Laurence C. Kelly, Park Ridge, IL (US)

(21) Appl. No.: 13/066,104

(22) Filed: Apr. 6, 2011

Related U.S. Application Data
(62) Division of application No. 11/525,449, filed on Sep. 22, 2006, now abandoned.
(60) Provisional application No. 60/786,150, filed on Mar. 27, 2006.

(51) Int. Cl. B01D 53/02

(52) U.S. Cl. 95/134

(57) ABSTRACT

A method for mitigating mercury vapor emissions during storing, staging, handling and transportation of an unbroken mercury containing universal waste lamp. The method includes the step of: placing the unbroken mercury containing universal waste lamp wholly within a container for storage, staging, handling or transportation. The container has an opening for allowing the unbroken mercury containing universal waste lamp to be placed wholly within the container. The container also has impervious wall structure for preventing mercury vapors from passing therethrough. The method also includes the step of: placing a predetermined amount of an activated carbon media having an affinity for mercury vapors within the container to passively adsorb mercury vapors escaping from incidental breakage of the mercury containing universal waste lamp. The next step involves closing the opening in the container such that when the container is closed the container is substantially airtight and vapors are prevented from passing from an interior to an exterior of said container and wherein the predetermined amount of activated carbon media within the closed container furthermore mitigates mercury vapors from inadvertently escaping from the container when the container is again opened

### RELATED APPLICATIONS

This patent application claims the benefit of provisional patent application Ser. No. 60/786,150; filed Mar. 27, 2006 and is a divisional patent application to co-pending U.S. patent application Ser. No. 11/525,449, filed Sep. 22, 2006.

### FIELD OF THE INVENTION DISCLOSURE

The present invention generally relates to mercury containing universal waste and, more specifically, to a method for mitigating mercury vapor emissions during storing, staging, handling and transportation of mercury containing universal waste.

### BACKGROUND OF THE INVENTION DISCLOSURE

Fluorescent lamps containing mercury are widely used in schools, factories, office buildings, shopping centers, as well as other smaller uses and require regular replacement. Spent mercury containing fluorescent and high intensity discharge (HID) lamps, ballasts, batteries, thermostats, thermometers, and related spent mercury containing devices are hereinafter commonly referred to as “mercury containing universal waste.” Disposal and/or recycling of such mercury containing universal waste has proven both costly and problematical.

Recycling of mercury containing universal waste has been regulated by both the United States Environmental Protection Agency and on a state by state basis because such spent product produces significant source of mercury vapors. 40 CFR Part 273 is one federal regulation relating to the recycling of such mercury containing universal waste. Additionally, OSHA has regulated uncontrolled emissions of mercury vapor in the workplace (Permissible Exposure Limit (PEL) not to exceed 0.100 mg/m³) since 1992. (See 29 C.F.R. Part 1910-1000). The USEPA and OSHA have each addressed both the sudden or immediate and non-sudden (prolonged buildup over time) environmental impairments mercury exposure create in the workplace. Both now recognize the subtle but very real and very hazardous consequences of prolonged exposure to mercury vapors exceeding the above-mentioned limits which can emanate when mercury containing universal waste is not properly handled.

In spaced locations throughout the country, there are processing facilities for rendering such mercury containing universal waste innocuous. To safely transport the mercury containing universal waste from a point of generation to such processing facilities, however, has been and continues to be an ongoing health issue. Besides breaking or fracturing of such mercury containing universal waste in the workplace, accidental breakage frequently occurs during the course of handling and transportation of the potentially hazardous toxic material to such a processing facility. Notably, all fluorescent lamps, including those deemed ecologically safe, contain at least 0.25 mg/m³ of mercury. Each time 3 or 4 lamps are broken during handling or transportation, mercury emissions are created which exceed OSHA standards ten fold.

Small to mid-size generators of mercury containing universal waste frequently use a mail-in program for transporting the mercury containing universal waste to an approved processing facility. A typical mail-in program requires the generator to package the mercury containing universal waste in a container which is thereafter transported, either by a common carrier or any one of several well known package delivery services, to a permitted processing facility for recycling. Depending upon the size of the mercury containing universal waste being shipped for recycling, some such containers can hold as many as 144 mercury containing lamps. Currently, the mercury containing universal waste being shipped must be identified as “hazardous” thus causing the small to mid-size generator to incur a very expensive transportation cost. Moreover, the drivers picking up and delivering those containers having mercury containing universal waste therewithin are continuously subjected to mercury vapor exposures emanating from universal waste traveling through their systems. As such, the drivers and other employees handling such containers are subjected to very high and bio-accumulative toxic mercury vapor exposure levels far exceeding published OSHA guidelines.

Thus, there is a continued need and desire for an economical method and apparatus for mitigating mercury vapor emissions during staging, storing, handling and transporting of unbroken mercury containing universal waste.

### SUMMARY OF THE INVENTION DISCLOSURE

According to one aspect, there is provided an apparatus for storing, staging, handling and transporting unbroken mercury containing universal waste in a manner mitigating mercury vapors escaping from such apparatus as a result of the breakage or fracturing the mercury containing universal waste. In one form, the apparatus includes a container having a closed bottom, sidewall structure extending from the closed bottom, and an opening for allowing insertion of the mercury containing universal waste into the container. The container opening is releasably closed by a cover or lid structure when the apparatus is transported between locations. An activated carbon media is arranged in the container after the opening is closed by the cover or lid structure. The activated carbon media has an affinity for mercury vapors escaping from any of the inadvertently broken mercury containing universal waste and thereby mitigates mercury vapors escaping from the apparatus.

In one form, the container holding the unbroken mercury containing universal waste is a disposable box fabricated from relatively rigid cardboard materials. In this form, the lid structure of the container comprises a pair of flaps foldable inwardly relative to the sidewall structure when the open-top of the container is to be closed. In another form, the container has a bucket-like configuration. In this form, the lid structure includes a cover releasably attachable to an upper end of the container. In either embodiment, the lid structure is preferably sealed, as with tape or the like, to the reminder of the container after the unbroken mercury containing universal waste is inserted thereinto and prior to shipment of the apparatus from one location to another.

The activated carbon media preferably comprises a predetermined volume of activated carbon material. In one form, the activated carbon material is enclosed within a porous envelope for adsorbing mercury vapors escaping from the mercury containing universal waste.

In a preferred embodiment, the apparatus for storing, staging, handling and transporting unbroken mercury containing universal waste further includes a non-porous liner within the container. The liner is configured to receive the unbroken mercury containing universal waste. To reduce the presence of mercury vapors resulting from inadvertent breakage of any of the mercury containing universal waste, an opening in the liner through which the unbroken mercury containing universal waste is inserted, is preferably sealed as with as with tape of the like.

According to another aspect, the apparatus for storing, staging, handling and transporting unbroken mercury containing universal waste includes a multisided container defining an opening through which the unbroken mercury containing universal waste is inserted into the container. The multisided container includes a pair of flaps for closing the opening when the container is transported between locations. An activated media is arranged within the container before the opening in the container is closed. The activated carbon media has an affinity for mercury vapors escaping from the inadvertently broken mercury containing universal waste. As such, the activated carbon media mitigates mercury vapors escaping from the apparatus.

Preferably, the activated carbon media includes an activated carbon material enclosed within a porous envelope. The activated carbon material in the apparatus adsorbs mercury vapors escaping from the mercury containing universal waste. The multisided container is preferably configured as a disposable box fabricated from relatively rigid cardboard materials. In one form, a non-porous liner receives and is accommodated within the multisided container.

According to another aspect, the apparatus for storing, staging, handling and transporting unbroken mercury containing universal waste includes a six sided container defining a generally horizontal elongated opening extending along a top of the container and through which the unbroken mercury containing universal waste is inserted into the container. The container further includes a generally horizontal and elongated bottom with side wall structure extending upwardly from the bottom. According to this aspect, the container further includes a pair of flaps for closing the opening when the container is transported between locations. A sealable non-porous liner is arranged within the container for receiving and accommodating the unbroken mercury containing universal waste inserted into the container. Moreover, an activated carbon media is arranged within the container. The activated carbon media has an affinity for mercury vapors resulting from inadvertently broken mercury containing universal waste. As such, the activated carbon media mitigates mercury vapors escaping from the apparatus.

Preferably, the activated carbon media includes a predetermined volume of activated carbon material enclosed within a porous envelope. In one form, the porous envelope includes a flexible, fiberglass mesh material having the predetermined volume of activated carbon material therewithin. To reduce costs, the porous envelope holding the activated carbon material is preferably reusable after the apparatus reaches the its final destination.

According to still another aspect, a method for mitigating mercury vapor emissions during storing, staging, handling and transportation of an unbroken mercury containing universal waste lamp is provided. The method includes the step of: placing the unbroken mercury containing universal waste lamp wholly within a container for storage, staging, handling or transportation. The container has an opening for allowing the unbroken mercury containing universal waste lamp to be placed wholly within the container. The container also has impervious wall structure for preventing mercury vapors from passing therethrough. The method also includes the step of: placing a predetermined amount of an activated carbon media, having an affinity for mercury vapors, within the container to passively adsorb mercury vapors escaping from incidental breakage of the mercury containing universal waste lamp. The next step involves closing the opening in the container such that when the container is closed the container is substantially airtight and vapors are prevented from passing from an interior to an exterior of said container and wherein the predetermined amount of activated carbon media within the closed container furthermore mitigates mercury vapors from inadvertently escaping from the container when the container is again opened.

The method for mitigating mercury vapor emissions during storing, staging, handling and transportation of an unbroken mercury containing universal waste lamp can further include the further step of: inserting the mercury containing universal waste into a non-porous liner accommodated within the container. Then, the open-top liner is sealed with the mercury containing universal waste therewithin prior to closing the container. Moreover, the cover or lid structure is preferably sealed to the container.

The activated carbon media preferably includes a predetermined volume of activated carbon materials enclosed within a porous envelope for adsorbing mercury vapors escaping from any one or more of inadvertently broken mercury containing universal waste lamps. In one form, the container into which the mercury containing universal waste is inserted is a disposable box fabricated from relatively rigid cardboard materials.

One feature of this invention relates to an economical apparatus for staging, storing, handling and transportation of unbroken mercury containing universal waste while rendering potentially high toxic mercury vapor emissions harmless by capturing such vapors at their point of generation inside a container in which the unbroken mercury containing universal waste is stored, staged, handled and transported.

Another feature of this invention relates to an apparatus allowing for mercury containing universal waste to be transported between distance locations without having to manage the mercury containing universal waste being transported as “hazardous” thus significantly reducing the transportation costs for such mercury containing universal waste.

Another feature of this invention relates to an apparatus for allowing mercury containing universal waste to be stored, staged, handled and transported in an economic fashion while protecting handlers and transporters moving such mercury containing universal waste to the proper processing facilities for recycling.

Still another aspect of this invention is to provide an economical apparatus for transporting unbroken mercury containing universal waste between locations while significantly reducing the toxic mercury vapor levels to which those individuals handling the apparatus are exposed.

These and other features, aims, and advantages of the present invention disclosure will become more readily apparent from the following detailed description, drawings and appended claims.

### DESCRIPTION OF THE DRAWINGS

FIG. 1 is a left top perspective view of one embodiment of an apparatus for storing, staging, handling and transporting unbroken mercury containing universal waste embodying principals of this invention disclosure;

FIG. 2 is a fragmentary side view of the apparatus shown in FIG. 1 with some panels of one form of container forming part of the present invention disclosure in unassembled condition relative to the remainder of the container;

FIG. 3 is an enlarged, fragmentary longitudinal sectional view of the container illustrated in FIG. 2 in partially assembled condition;

FIG. 4 is an enlarged fragmentary longitudinal sectional view schematically showing a liner inserted into the container;

FIG. 5 is a fragmentary top plan view of the liner shown in FIG. 4 in a sealed condition;

FIG. 6 is a fragmentary longitudinal sectional view of one form of the invention disclosure;

FIG. 7 is a top plan view of one form of a packet for holding an activated carbon media forming part of the present invention disclosure;

FIG. 8 is a sectional view taken along line 8-8 of FIG. 7;

FIG. 9 is a side elevational view of another embodiment of an apparatus for storing, staging, handling and transporting unbroken mercury containing universal waste embodying principals of the present invention disclosure; and

FIG. 10 is an enlarged fragmentary view, partly in section, of an upper end of a container and lid structure forming part of the present invention disclosure.

### DETAILED DESCRIPTION OF THE INVENTION DISCLOSURE

While the present invention is susceptible of embodiment in multiple forms, there is shown in the drawings and will hereinafter be described preferred embodiments of the invention disclosure, with the understanding the present disclosure sets forth exemplifications which are not intended to limit the invention disclosure to the specific embodiments illustrated and described.

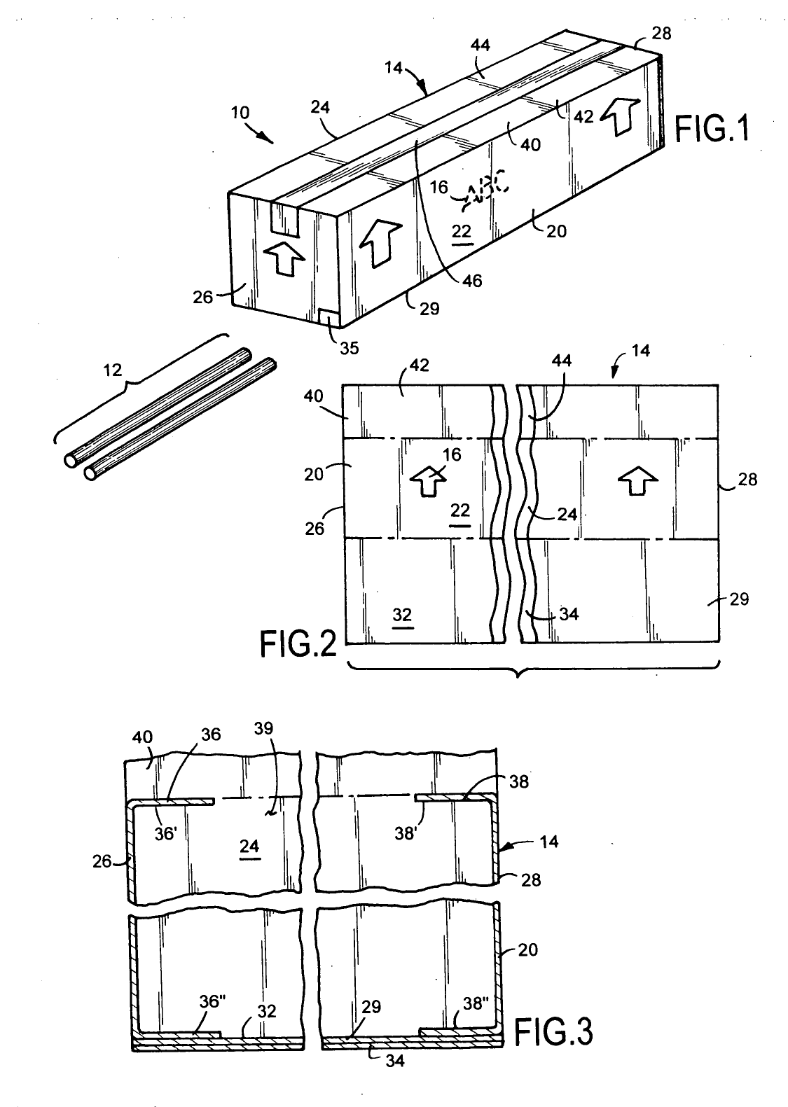

Referring now to the drawings, wherein like reference numerals indicate like parts throughout the several view, there is shown in FIG. 1 an apparatus, generally identified by reference numeral 10, for storing, staging, handling and transporting unbroken mercury containing universal waste, generally identified by reference numeral 12 in FIG. 1. In FIG. 1, the unbroken mercury containing universal waste 12 is illustrated, for exemplary purposes, as being elongated and unbroken mercury containing fluorescent bulbs or lamps. It should be appreciated, however, the unbroken mercury containing universal waste 12 can have other shapes, sizes and configurations other than shown for exemplary purposes without detracting or departing from the spirit and scope of the invention disclosure.

Apparatus 10 includes a container 14 which is configured depending upon the type and size of unbroken mercury containing universal waste being stored, staged, handled and transported. That is, container 14 can take the form of a box, a bag, a bucket or other suitable configuration without detracting or departing from the spirit and novel scope of this invention disclosure. In the exemplary embodiment illustrated in FIG. 1, container 14 has a multisided configuration with suitable indicia 16 on one or more of the exterior surfaces thereof. In the form shown in FIG. 1, container 14 is sized with about a 48 inch length, about a 12 inch width, and about a 12 inch height for accommodating, or storing, or staging unbroken mercury containing universal waste lamps within the confines of the container 14. When so designed, container can hold about 144 unbroken and elongated mercury containing fluorescent bulbs or lamps therewithin.

In the exemplary embodiment shown in FIG. 1, container 14 includes sidewall structure 20 comprising elongated front and rear, generally parallel and flat panels 22 and 24, respectively, joined to a pair of generally parallel and flat end panels 26 and 28 (FIGS. 1 and 3). As shown, the sidewall structure 20 of container 14 is arranged in upstanding relation relative to a longitudinally elongated and closed bottom 29.

As shown in FIG. 2, the bottom 29 of container 14 preferably includes two elongated and generally flat panels 32 and 34 which, in one form, are hinged along a lower edge of the front and rear panels 22 and 24, respectively. In the illustrated embodiment, each bottom panel 32, 34 has a width equal to a width of the end panels 26, 28 (FIG. 1) so as to add strength and rigidity to the container 14. An elongated adhesive tape strip 35 (FIG. 1) serves to secure the lowermost of the bottom panels 32, 34 in a closed position relative to the remainder of the container 14. It will be appreciated, however, the bottom 29 of container 14 can have configurations other than that shown without detracting or departing from the spirit and scope of the present invention.

Preferably, and as shown in FIG. 3, container 14 further includes a two pairs of end flaps 36 and 38 which fold inwardly generally at right angles relative to their respective end panel 26, 28 when container 14 is closed for transport. In the illustrated embodiment, the first pair of end flaps 36 include flaps 36′ and 36″ which, preferably, are as wide as and are hingedly connected along upper and lower edges of end panel 26. In the illustrated embodiment, the other pair of end flaps 38 include flaps 38′ and 38″ which, preferably, are as wide as and are hingedly connected along upper and lower edges of end panel 28 of container 14.

As shown in FIG. 3, container 14 defines an elongated opening 39 through which unbroken mercury containing universal waste is inserted into apparatus 10. Lid structure or cover 40 serves to releasably close the open-top 39 of the container 14 after the mercury containing universal waste is inserted into the container 14 for transport. In the embodiment shown in FIGS. land 2, lid structure 40 includes a pair of longitudinally elongated flaps or panels 42 and 44 preferably hinged to fold at right angles relative to and inwardly of the front and rear panels 22 and 24, respectively. As will be appreciated, and when folded into a closed condition (FIG. 1), panels 42 and 44 combine with each other to extend across and close the open-top 39 of apparatus 10. Preferably, flaps 36′, 38′ underlie and add support to the panels 42, 44 when the container 14 is closed. Moreover, and after the panels 42, 44 are arranged to close the top 39 of the container 14, an elongated adhesive tape strip 46 extends across the exterior to maintain the lid structure 40 in closed position. Preferably, the tape strip 46 furthermore serves to seal apparatus 10.

Container 14 is preferably fabricated from relatively rigid cardboard material or other suitable material which is impervious to vapors or gases passing through the wall structure thereof and such that, when the container 14 is in a closed condition (FIG. 1), the container 14 is substantially airtight and vapors from one or more inadvertently broken lamps in the container 14 are prevented from passing from an interior to an exterior of the container 14. Since the preferred embodiment of container 14 is fabricated from cardboard, it can be economically designed and is considered disposable. In one form, the cardboard material forming container 14 is corrugated to add to the strength of the container 14 while reducing the weight thereof.

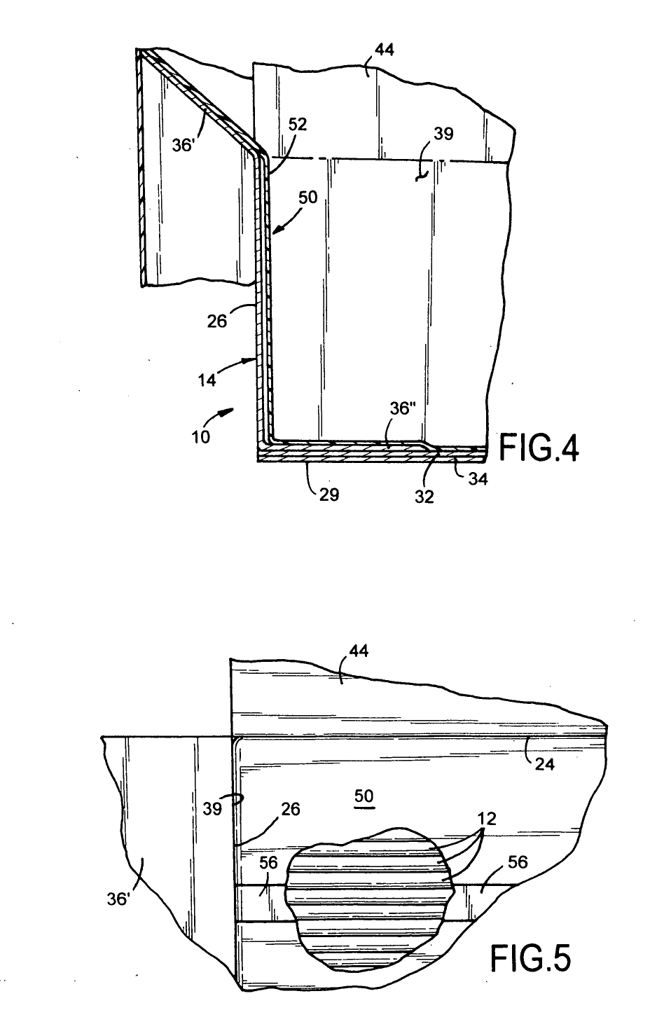

In the form shown in FIG. 4, apparatus 10 further includes a liner 50 for the container 14. Liner 50 has an open-top 52 arranged in registry with the open-top 39 of the container 14 and through which the mercury containing universal waste is inserted into the container 14. Liner 50 is preferably formed from a non-porous material such as plastic or the like. Liner 50 has a suitable thickness to inhibit inadvertent tearing of the liner material as the unbroken mercury containing universal waste is received therewithin. Preferably, liner 50 can range in thickness from about 1.5 mils to about 6 mils. In a most preferred form, liner 50 has a thickness of about 2 mils. To optimize the load carrying capacity of apparatus 10, liner 50 preferably has gussetted corners so as to allow liner 50 to better fit within the container 14.

Suffice it to say, liner 50 is sized relative to the interior of the container 14 such that after the unbroken mercury containing universal waste is received through the opening 52 to liner 50, sufficient liner material remains allowing the free ends of the liner 50 to be laid over each other, preferably in a multifolded fashion, to operably close the open-top 52 of the liner. Preferably, and as shown in FIG. 5, after the liner 50 is operably closed, an adhesive strip of tape-like material 56 operably seals the closed top of the liner 50 to inhibit mercury vapors from escaping therefrom.

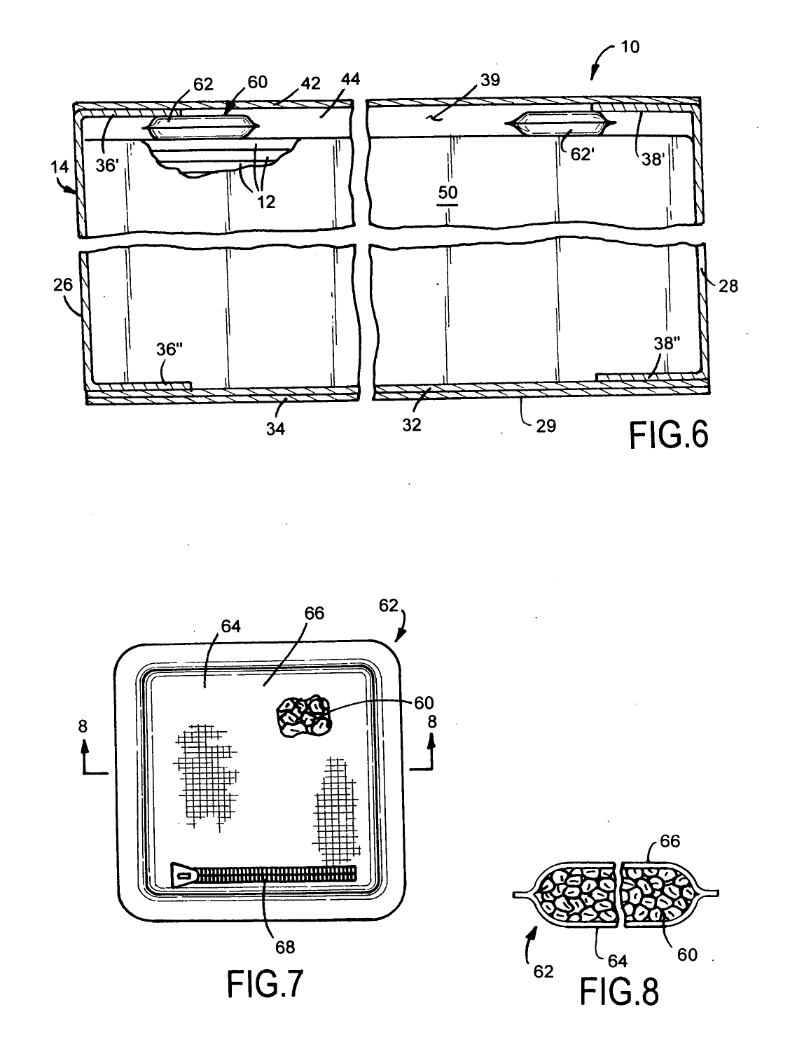

Apparatus 10 further includes a mercury vapor adsorption system for reducing mercury vapor concentrations within container 14 to a level below detectable limits. As shown in FIG. 6, transportation apparatus 10 includes a predetermined amount activated carbon media 60 held in the container 14 after the opening 39 is closed by the lid structure 40. Preferably, the activated carbon media is movable within the container 14 and outside of the sealed liner 50. Notably, the activated carbon media 60 has an affinity for mercury vapors escaping from the inadvertently broken mercury containing universal waste thereby furthermore mitigating mercury vapors from inadvertently escaping from the apparatus 10.

As shown in FIG. 6, the activated carbon media 60 is preferably carried and maintained within a packet 62 including a predetermined amount or volume of activated carbon material of the type sold by Calgon Carbon Corporation of Pittsburgh, Pa. under Type HGR® activated carbon. As will be appreciated, apparatus 60 can include more than one packet of activated carbon material 62′ without detracting or departing from the spirt and scope of the invention.

Turning to FIGS. 7 and 8, each packet 62 includes a porous envelope 64 for holding a predetermined amount or volume of activated carbon material 60 therewithin. The predetermined amount or volume of activated carbon material in each packet 62 is treated to adsorb mercury vapors escaping from the mercury containing universal waste being transported within the container 14. In the exemplary form shown in FIG. 8, the porous envelope 64 is fabricated from a flexible and pliable fiberglass mesh material 66 which is sealed to inhibit the activated carbon material from escaping therefrom. In that form shown in FIG. 7, envelope 64 includes a resealable closure apparatus 68, i.e., a zipper, or other conventional resealable securing device so as to allow activated carbon materials to be added, replaced or exchanged.

When manufactured, mercury containing fluorescent bulbs or lamps are under negative air. Accordingly, when they break, such lamps implode rather than explode. The vacuum created when such lamps break within the container 14, initially traps the escaping mercury vapors for about 30 to 40 seconds, thus, allowing the activated carbon media 66 within each packet 64 to adsorb the mercury vapors in a timely and efficient manner.

The elongated configuration of the container 14 coupled with the elongated open-top 39 design yields several unique advantages. First, the elongated configuration of the container 14 and, more specifically, the horizontally elongated and closed bottom 29 adds stability to the container 14. As such, the container 14 will be less likely to tip over and fall during staging of the mercury containing universal waste therewith. Since container 14 is less likely to tip and fall, there is less likelihood the mercury containing universal waste stored for transportation therewithin will fracture and/or break thereby further reducing the possibility of mercury vapors escaping into the ambient atmosphere. Second, the horizontally elongated configuration of the container 14 adds stability during transport of apparatus 10. Known devices for transporting mercury containing universal waste have an open end. As such, and when arranged in a lamp staging area, such known transport devices commonly attract an accumulation of trash therewithin. As will be appreciated, removing trash from a four foot long vertical container is exceptionally difficult without having to tip or otherwise invert the container. Designing the container 14 with a lower horizontally elongated profile—rather than a vertical profile—tends to not attract trash as frequently as the vertically disposed and designed containers. Additionally, the lower horizontal profile of container 14 significantly reduces, bunching, tearing and/or ripping of liner 50 as the mercury containing universal waste is loaded thereinto.

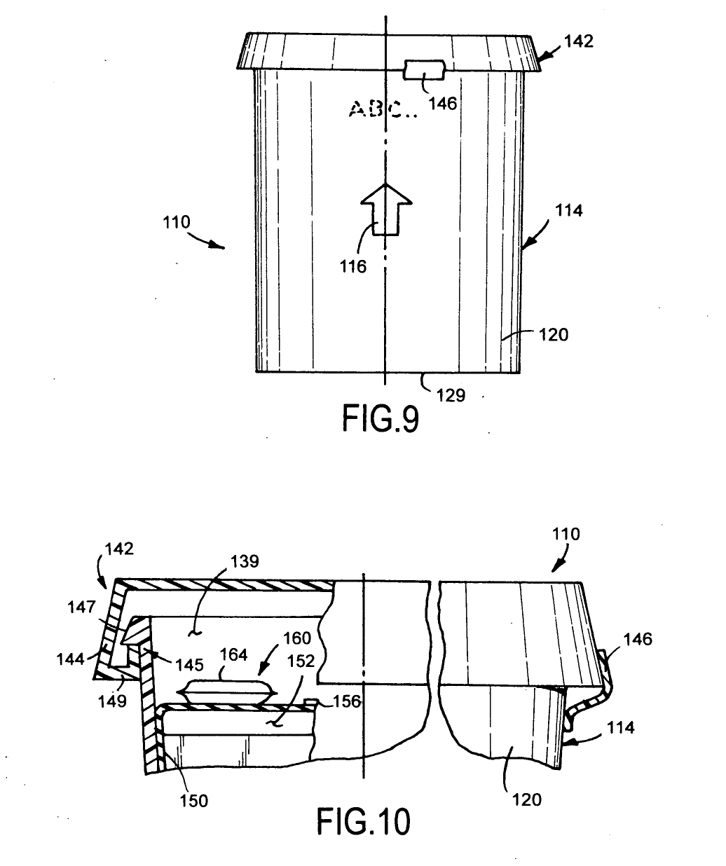

An alternative form of apparatus for staging, storing, handling and transporting unbroken mercury containing universal waste between locations and embodying features of the present invention disclosure is illustrated in FIGS. 9 and 10. This alternative form of apparatus for storing, staging, handling and transporting unbroken mercury containing universal waste is designated generally by reference numeral 110. The elements of this apparatus for storing, staging, handling and transporting unbroken mercury containing universal waste that are identical or functionally analogous to those components discussed above regarding apparatus 10 are designated by reference numerals identical to those used above with the exception this embodiment uses reference numerals in the 100 series.

As shown in FIG. 9, the apparatus 110 for storing, staging, handling and transporting mercury containing universal waste between locations includes a container 114 having a bucket-like configuration. Suitable indicia 116 can be imprinted on an exterior of the container 114. As shown in FIG. 9, container 114 comprises sidewall structure 120 arranged in upstanding relation relative to a closed bottom 129. In the illustrated embodiment, the closed bottom 129 is formed integral with the upstanding sidewall structure 120. In a most preferred form, container 114 is fabricated from a suitable and relatively rigid plastic material substantially impervious to vapors or gasses passing therethrough.

As shown in FIG. 10, toward an upper end, container 114 defines an open-top 139 through which the mercury containing universal waste is inserted into the container 114. After the unbroken mercury containing universal waste is inserted into the container 114, the open-top 139 of the container 114 is releasably closed by lid structure or cover 142. In the illustrated embodiment, container 114 and a depending skirt portion 144 of lid structure 142 embody cooperating instrumentalities 145. Such cooperating instrumentalities 145 can take a myriad of different designs such as cooperating thread-like configurations or the like. In the illustrated embodiment, an annular protrusion 147 is provided toward the upper end of the container 114. Such annular protrusion 147 on container 114 cooperates in a well known manner with suitable conventional structure 149 on the skirt portion 144 of the lid structure 142 to releasably secure the container 114 and lid structure 142 in operable combination.

Apparatus 110 furthermore preferably includes a liner 150 for container 114. In the form shown in FIG. 10, liner 150 has an open-top 152 through which the unbroken mercury containing universal waste is inserted into the liner 150 and container 114. As mentioned with respect to liner 50 above, liner 150 is sized such that after the unbroken mercury containing universal waste is received through the opening 152, sufficient liner material remains allowing the free ends of the liner 152 to be laid over each other, preferably in a multifolded fashion, to operably close the open-top 152 of the liner 150. Preferably, after the liner 152 is operably closed, an adhesive strip of tape-like material or a suitable twist-tie 156 operably seals the closed top of the liner 150 to inhibit mercury vapors from escaping therefrom.

Like apparatus 10, and as shown in FIG. 10, apparatus 110 includes a predetermined amount or volume of activated carbon media 160 which serves as a mercury vapor adsorption system and reduces mercury vapor concentrations within container 114 to a level below detectable limits. Like that discussed above in detail, the activated carbon media 160 is preferably in the form of at least one packet 164 containing activated carbon material. As will be appreciated, apparatus 110 can include more than one packet of activated carbon material without detracting or departing from the spirt and scope of the invention.

After the unbroken mercury containing universal waste is inserted into container 114 and cover 142 is arranged to operably close the open-top 139 of container 114, an adhesive tape strip 146 (FIG. 9) annularly extends about and between the container 114 and cover 142 to maintain the cover 142 in a closed condition. Preferably, the tape strip 46 furthermore serves to seal apparatus 110.

Regardless of the particular shape of the container used to store, stage, handle or transport the unbroken mercury containing universal waste, the activated carbon media arranged within the container is preferably designed to adsorb at least three times the total amount of mercury vapor emissions that could possibly be generated by the mercury containing universal waste within the container. During the adsorption process, mercury is attracted to the surface of the activated carbon media where a chemical reaction converts the mercury to mercuric sulfide. The sulfide product is then retained in the pores of the activated carbon granules. Preferably, the mercury capacity of the carbon media is as high as 20% by weight.

The activated carbon media within each transport container captures mercury vapor emissions at their point of generation thereby mitigating mercury vapors from escaping from the apparatus of the present invention disclosure. As such, transport companies will no longer be driven to manage the mercury containing universal waste being shipped for processing as “hazardous”, thus, significantly decreasing the transportation costs thus allowing the generators of such mercury containing universal waste to pro-actively participate in affordable recycling programs while concurrently decreasing their liability issues.

In a preferred form, each packet of activated carbon material weighs less than eight (8) ounces and, thus, does not add to the transportation costs involved with the apparatus of the present invention. Moreover, each packet of activated carbon material is reusable several different times before the adsorption level of the activated carbon media is adversely affected.

According to another aspect of this invention disclosure, there is provided a method for mitigating mercury vapor emissions during storing, staging, handling and transportation of one or more unbroken mercury containing universal waste lamp, comprising the steps of:. The method involves the steps of: placing the at least one or more unbroken mercury containing universal waste lamps within a container sized to accommodate the at least one or more unbroken mercury containing universal waste lamp within confines defined by the container. The container has an impervious bottom along with impervious sidewall structure extending upward from the bottom, and an opening for allowing the unbroken mercury containing universal waste lamps to be inserted into the container. Another step in the methodology involves: placing a predetermined amount of an activated carbon media having an affinity for mercury vapors within the container. The activated carbon media is movable within the container and passively adsorbs mercury vapor escaping from incidental breakage of any one or more of the plurality of mercury containing universal waste lamps placed into the confines of the container for storage, staging, handling or transportation of the lamps. Then, the opening in said container is closed with a cover such that when the container is closed the container is substantially airtight and vapors are prevented from passing from an interior to an exterior of the container whereby mitigating mercury vapors from inadvertently escaping from the container, and wherein the predetermined amount of activated carbon media within the closed container furthermore mitigates mercury vapors from inadvertently escaping from the container when the container is again opened.

Preferably, the method for mitigating mercury vapor emissions during storing, staging, handling and transportation of one or more unbroken mercury containing universal waste lamp includes the further step of: sealing the container after closing the opening on the container to furthermore mitigate mercury vapors from inadvertently escaping from the container. In one form, the method for mitigating mercury vapor emissions during storing, staging, handling and transportation of one or more unbroken mercury containing universal waste lamp includes the further step of: providing a porous envelope into which the predetermined amount of activated carbon media is contained and transported for adsorbing mercury vapors escaping from the incidental breaking of one or more of the mercury containing universal waste lamps.

According to a preferred form, the method for mitigating mercury vapor emissions during storing, staging, handling and transportation of one or more unbroken mercury containing universal waste lamp includes the further step of: fabricating the container from relatively rigid cardboard materials thereby rendering the container disposable. In a preferred form, the cover of the container comprises a pair of flaps foldable inwardly relative to said sidewall structure on said container when the opening defined by the container is to be closed.

Moreover, the method for mitigating mercury vapor emissions during storing, staging, handling and transportation of one or more unbroken mercury containing universal waste lamp preferably includes the further step of: providing a non-porous liner within the container for receiving and accommodating the one or more unbroken mercury containing universal waste lamps inserted into the container. When a non-porous liner is provided for receiving and accommodating the one or more unbroken mercury containing universal waste lamps inserted into the container, the method for mitigating mercury vapor emissions during storing, staging, handling and transportation of one or more unbroken mercury containing universal waste lamp preferably includes the further step of: sealing the non-porous liner after the one or more unbroken mercury containing universal waste lamps are inserted into the container to furthermore mitigate mercury vapors from inadvertently escaping from the container.

From the foregoing, it will be observed that numerous modifications and variations can be made and effected without departing or detracting from the true spirit and novel concept of the present invention. Moreover, it will be appreciated, the present disclosure is intended to set forth an exemplification of the invention which is not intended to limit the invention to the specific embodiment illustrated. Rather, this disclosure is intended to cover by the appended claims all such modifications and variations as fall within the spirit and scope of the claims.

What is claimed is:

1. A method for mitigating mercury vapor emissions during storing, staging, handling and transportation of unbroken mercury containing universal waste lamps, comprising the steps of:
placing a plurality of unbroken mercury containing universal waste lamps within a container sized to accommodate said plurality of unbroken mercury containing universal waste lamps within confines defined by said container, with said container having an impervious bottom, impervious sidewall structure extending upward from said bottom, and an opening for allowing the unbroken mercury containing universal waste lamps to be inserted into the container:
placing a predetermined amount of an activated carbon media having an affinity for mercury vapors within said container, with said activated carbon media being movable within said container to passively adsorb mercury vapor escaping from incidental breakage of any one or more of the plurality of mercury containing universal waste lamps placed into the confines of said container during storage, staging, handling or transportation of said lamps; and
closing the opening on said container with a cover such that when said container is closed the container is substantially airtight and vapors are prevented from passing from an interior to an exterior of said container whereby mitigating mercury vapors from inadvertently escaping from said container, and wherein the predetermined amount of activated carbon media within said closed container furthermore mitigates mercury vapors from inadvertently escaping from said container when said container is again opened.

2. The method according to claim 1 wherein, including the further step of:
sealing said container after closing the opening on said container to furthermore mitigate mercury vapors from inadvertently escaping from said container.

3. The method according to claim 1 wherein, including the further step of:
providing a porous envelope into which said predetermined amount of activated carbon media is contained and transported for adsorbing mercury vapors escaping from the incidental breaking of any one or more of said mercury containing universal waste lamps.

4. The method according to claim 1 wherein, said container is a disposable box fabricated from relatively rigid cardboard materials.

5. The method according to claim 4 wherein, the cover of said container comprises a pair of flaps foldable inwardly relative to said sidewall structure on said container when the opening defined by said container is to be closed.

6. The method according to claim 1 further including the step of:
providing a non-porous liner within said container for receiving and accommodating said unbroken mercury containing universal waste lamps inserted into said container.

7. The method according to claim 1 further including the step of sealing said non-porous liner after the unbroken mercury containing universal waste lamps are inserted into said container to furthermore mitigate mercury vapors from inadvertently escaping from said container.

8. A method for mitigating mercury vapor emissions during storing, staging, handling and transportation of unbroken mercury containing universal waste, comprising the steps of:
placing a plurality of unbroken mercury containing universal waste lamps within a multisided container sized to accommodate said unbroken mercury containing universal waste lamps within confines of said container, with sides and a bottom of said container being impervious to vapors passing from an interior to an exterior of said container, and with said container defining an opening through which said mercury containing universal waste lamps are placed into said container, with said multisided container including at least one hinged flap for closing said opening such that when said container is closed the container is substantially airtight and vapors are prevented from escaping from said container; and
placing a predetermined amount of an activated carbon media having an affinity for mercury vapors within the confines of said container, with said activated carbon media being movable within said container and serves to passively adsorb mercury vapor escaping from incidental breakage of any one or more of said plurality of mercury containing universal waste lamps placed into said container during storage, staging, handling or transporting of said lamps; and
closing the opening on said container with a cover such that when said container is closed the container is substantially airtight and vapors are prevented from passing from an interior to an exterior of said container whereby mitigating mercury vapors from inadvertently escaping from said container, and wherein the predetermined amount of an activated carbon media within said closed container furthermore mitigates mercury vapors from inadvertently escaping from said container when said container is again opened.

9. The method according to claim 8 wherein, including the further step of:
sealing said container after closing the opening on said container to furthermore mitigate mercury vapors from inadvertently escaping from said container.

10. The method according to claim 8 wherein, including the further step of:
providing a porous envelope into which said predetermined amount of activated carbon media is contained and transported for adsorbing mercury vapors escaping from the incidental breaking of any one or more of said mercury containing universal waste lamps.

11. The method according to claim 8 wherein, said container is a disposable box fabricated from relatively rigid cardboard materials.

12. The method according to claim 8 further including the step of:
providing a non-porous liner within said container for receiving and accommodating said unbroken mercury containing universal waste lamps inserted into said container.

13. The method according to claim 12 further including the step of:
sealing said non-porous liner after the unbroken mercury containing universal waste lamps are inserted into said container to furthermore mitigate mercury vapors from inadvertently escaping from said container.

14. A method for mitigating mercury vapor emissions during storing, staging, handling and transportation of an unbroken mercury containing universal waste lamp, comprising the steps of:
placing the unbroken mercury containing universal waste lamp wholly within a container sized to accommodate said unbroken mercury containing universal waste lamp wholly for storage, staging, handling or transportation, with said container having a closed impervious bottom, impervious sidewall structure extending upward from said closed bottom, and an opening for allowing the mercury containing universal waste lamp to be wholly inserted into said container;
placing a predetermined amount of an activated carbon media having an affinity for mercury vapors within in said container to passively adsorb mercury vapors escaping from incidental breakage of said mercury containing universal waste lamp; and
closing the opening in said container with a cover such that when said container is closed the container is substantially airtight and vapors are prevented from passing from an interior to an exterior of said container and wherein the predetermined amount of activated carbon media within said closed container furthermore mitigates mercury vapors from inadvertently escaping from said container when said container is again opened

15. The method according to claim 14 wherein, including the further step of:
sealing said container after closing the opening on said container to furthermore mitigate mercury vapors from inadvertently escaping from said container.

16. The method according to claim 14 wherein, including the further step of:
providing a porous envelope into which said predetermined amount of activated carbon media is contained and transported for adsorbing mercury vapors escaping from the incidental breaking of said mercury containing universal waste lamp.
